(19) United States
(12) Patent Application Publication
(10) Pub. No.: US 2025/0173239 A1
(43) Pub. Date: May 29, 2025

(54) MODEL PERFORMANCE EVALUATING METHODS, APPARATUSES, DEVICE AND STORAGE MEDIUM

(71) Applicants: Beijing Bytedance Network Technology Co., Ltd., Beijing (CN); Lemon Inc., Grand Cayman (KY)

(72) Inventors: Jiankai SUN, Los Angeles, CA (US); Xin YANG, Los Angeles, CA (US); Chong WANG, Los Angeles, CA (US); Junyuan XIE, Beijing (CN); Di WU, Beijing (CN)

(21) Appl. No.: 18/839,702

(22) PCT Filed: Apr. 27, 2023
(86) PCT No.: PCT/CN2023/091156

§ 371 Date: Aug. 19, 2024

(30) Foreign Application Priority Data
May 13, 2022 (CN) 202210524000.6

(51) Int. Cl. G06F 11/34; G06F 21/62

(52) U.S. Cl. CPC G06F 11/3447; G06F 21/6245

(57) ABSTRACT

Here provide a model performance evaluating method, an apparatus, a device, and a storage medium. The method includes: determining, at a client node, a plurality of predicted classification results corresponding to a plurality of data samples by comparing a plurality of predicted scores to a score threshold, the plurality of predicted scores being output by a machine learning model for the plurality of data samples, the plurality of predicted classification results indicating that the plurality of data samples are predicted to belong to a first category or a second category, respectively. The method further includes: determining values of a plurality of metric parameters associated with a predetermined performance indicator of the machine learning model based on differences between the plurality of predicted classification results and a plurality of ground-truth classification results corresponding to the plurality of data samples.

This disclosure claims priority to Chinese Patent Application No. 202210524000.6, filed with the Chinese Patent Office on May 13, 2022 and entitled “MODEL PERFORMANCE EVALUATING METHODS, APPARATUSES, DEVICE AND STORAGE MEDIUM”, which is incorporated herein by reference in its entirety.

### FIELD

Example embodiments of the present disclosure generally relate to the field of computers, and in particular, to methods, apparatuses, a device, and a computer readable storage medium for model performance evaluating.

### BACKGROUND

As the data privacy protection problem becomes more and more important, it is difficult to further improve the current centralized machine learning system. Therefore, federated learning is emerging. Federated learning can achieve performance consistent with traditional machine learning algorithms in an encrypted environment when data leaves a local node. Federated learning refers to realizing co-modelling by utilizing data of various nodes on the basis of ensuring data privacy security, and improving the effect of a machine learning model. Federated learning can allow each node not to leave an end, so as to achieve the purpose of data protection. In federated learning, it is expected that a data privacy scheme can be better protected, including the privacy of label data corresponding to a data sample.

### SUMMARY

According to example embodiments of the present disclosure, a solution for evaluating model performance is provided.

In a first aspect of the present disclosure, a method for evaluating model performance is provided. The method comprises: determining, at a client node, a plurality of predicted classification results corresponding to a plurality of data samples by comparing a plurality of predicted scores to a score threshold, the plurality of predicted scores being output by a machine learning model for the plurality of data samples, the plurality of predicted classification results indicating that the plurality of data samples are predicted to belong to a first category or a second category, respectively. The method further comprises: determining values of a plurality of metric parameters associated with a predetermined performance indicator of the machine learning model based on differences between the plurality of predicted classification results and a plurality of ground-truth classification results corresponding to the plurality of data samples. The method further comprises: applying perturbation to the values of the plurality of metric parameters, to obtain perturbed values of the plurality of metric parameters. The method further comprises: sending the perturbed values of the plurality of metric parameters to a server node.

In a second aspect of the present disclosure, a method for evaluating model performance is provided. The method comprises: receiving, at a server node, perturbed values of a plurality of metric parameters from at least one group of client nodes associated with a predetermined performance indicator of a machine learning model, respectively. The method also comprises: for each of the at least one group of client nodes, aggregating the perturbed values of the plurality of metric parameters from the group of client nodes in a metric parameter-wise way, to obtain aggregated values of the plurality of metric parameters respectively corresponding to the at least one group. The method also comprises: determining a value of the predetermined performance indicator based on at least one score threshold value respectively associated with the at least one group, and the aggregated values of the plurality of metric parameters respectively corresponding to the at least one group.

In a third aspect of the present disclosure, an apparatus for evaluating model performance is provided. The apparatus comprises a classification determining module configured to determine a plurality of predicted classification results corresponding to a plurality of data samples by comparing a plurality of predicted scores to a score threshold, the plurality of predicted scores being output by a machine learning model for the plurality of data samples, the plurality of predicted classification results indicating that the plurality of data samples are predicted to belong to a first category or a second category, respectively. The apparatus also comprises a metric parameter determination module configured to determine values of a plurality of metric parameters associated with a predetermined performance indicator of the machine learning model based on differences between the plurality of predicted classification results and a plurality of ground-truth classification results corresponding to the plurality of data samples. The apparatus further comprises a perturbation module configured to apply perturbation to the values of the plurality of metric parameters, to obtain perturbed values of the plurality of metric parameters. The apparatus also comprises a perturbed value sending module configured to send the perturbed values of the plurality of metric parameters to a server node.

In a fourth aspect of the present disclosure, an apparatus for evaluating model performance is provided. The apparatus comprises a perturbed value receiving module configured to receive, at a server node, perturbed values of a plurality of metric parameters from at least one group of client nodes associated with a predetermined performance indicator of a machine learning model, respectively. The apparatus further comprises an aggregation module configured to aggregate, for each of the at least one group, the perturbed values of the plurality of metric parameters from the group of client nodes in a metric parameter-wise way, to obtain aggregated values of the plurality of metric parameters respectively corresponding to the at least one group. The apparatus also comprises a metric determination module configured to determine a value of the predetermined performance indicator based on at least one score threshold value respectively associated with the at least one group, and the aggregated values of the plurality of metric parameters respectively corresponding to the at least one group.

In a fifth aspect of the present disclosure, an electronic device is provided. The device comprises at least one processing unit; and at least one memory coupled to the at least one processing unit and storing instructions for execution by the at least one processing unit that, when executed by the at least one processing unit, cause the device to perform the method of the first aspect.

In a sixth aspect of the present disclosure, an electronic device is provided. The device comprises at least one processing unit; and at least one memory coupled to the at least one processing unit and storing instructions for execution by the at least one processing unit that, when executed by the at least one processing unit, cause the device to perform the method of the second aspect.

In a seventh aspect of the disclosure, a computer readable storage medium having a computer program stored thereon is provided. The computer program, when executed by a processor, implements the method of the first aspect.

In an eighth aspect of the disclosure, a computer readable storage medium a computer program stored thereon is provided. The computer program, when executed by a processor, implements the method of the second aspect.

It should be appreciated that what is described in the Summary is not intended to limit the critical features or essential features of the embodiments of the disclosure, nor is it intended to limit the scope of the disclosure. Other features of the present disclosure will become readily appreciated from the following description.

### BRIEF DESCRIPTION OF THE DRAWINGS

The above and other features, advantages, and aspects of various embodiments of the present disclosure will become more apparent with reference to the following detailed description taken in conjunction with the accompanying drawings. In the drawings, the same or similar reference numerals denote the same or similar elements, wherein:

FIG. 1 shows a schematic diagram of an example environment in which embodiments of the present disclosure can be applied;

FIG. 2 illustrates a flowchart of a signaling flow for evaluating model performance according to some embodiments of the present disclosure;

FIG. 3 illustrates a flowchart of a process of applying perturbation according to some embodiments of the present disclosure;

FIG. 4 illustrates a schematic of an ROC curve according to some embodiments of the present disclosure;

FIG. 5 shows a flowchart of a process of evaluating model performance according to some embodiments of the present disclosure;

FIG. 6 illustrates a flowchart of another process of evaluating model performance according to some embodiments of the present disclosure;

FIG. 7 illustrates a block diagram of another apparatus for evaluating model performance according to some embodiments of the present disclosure;

FIG. 8 illustrates a block diagram of an apparatus for evaluating model performance according to some embodiments of the present disclosure; and

FIG. 9 illustrates a block diagram of a computing device/system capable of implementing one or more embodiments of the present disclosure.

### DETAILED DESCRIPTION

Embodiments of the present disclosure will be described in more detail below with reference to the accompanying drawings. Although some embodiments of the present disclosure are shown in the drawings, it would be appreciated that the present disclosure can be implemented in various forms and should not be interpreted as limited to the embodiments described herein. On the contrary, these embodiments are provided for a more thorough and complete understanding of the present disclosure. It would be appreciated that the drawings and embodiments of the present disclosure are only for illustrative purposes and are not intended to limit the scope of protection of the present disclosure.

In the description of the embodiments of the present disclosure, the term “including” and similar terms should be understood as open-ended inclusion, that is, “including but not limited to”. The term “based on” should be understood as “at least partially based on”. The terms “one embodiment” or “the embodiment” should be understood as “at least one embodiment”. The term “some embodiments” should be understood as “at least some embodiments”. The following may also include other explicit and implicit definitions.

It can be understood that the data involved in this technical solution (including but not limited to the data itself, data observation or use) should comply with the requirements of corresponding laws, regulations and relevant provisions.

It is to be understood that, before applying the technical solutions disclosed in various implementations of the present disclosure, the user should be informed of the type, scope of use, and use scenario of the personal information involved in the subject matter described herein in an appropriate manner in accordance with relevant laws and regulations, and user authorization should be obtained.

For example, in response to receiving an active request from the user, prompt information is sent to the user to explicitly inform the user that the requested operation would acquire and use the user's personal information. Therefore, according to the prompt information, the user may decide on his/her own whether to provide the personal information to the software or hardware, such as electronic devices, applications, servers, or storage media that execute operations of the technical solutions of the present disclosure.

As an optional but non-limiting implementation, in response to receiving an active request from the user, the way of sending the prompt information to the user may, for example, include a pop-up window, and the prompt information may be presented in the form of text in the pop-up window. In addition, the pop-up window may also carry a select control for the user to choose to “agree” or “disagree” to provide the personal information to the electronic device.

It is to be understood that the above process of notifying and obtaining the user authorization is only illustrative and does not limit the implementations of the present disclosure. Other methods that satisfy relevant laws and regulations are also applicable to the implementations of the present disclosure.

As used herein, the term “model” may learn the correlation relationship between corresponding inputs and outputs from training data, so that corresponding outputs may be generated for given inputs after training. The generation of the model may be based on machine learning technology. Deep learning is a machine learning algorithm that processes inputs and provides corresponding outputs by using a plurality of layers of processing units. Neural networks models are an example of deep learning-based models. Herein, “model” may also be referred to as “machine learning model”, “learning model”, “machine learning network”, or “learning network”, and these terms are used interchangeably herein.

A “neural network” is a machine learning network based on deep learning. Neural networks are capable of processing inputs and providing corresponding outputs, and typically include an input layer and an output layer and one or more hidden layers between the input layer and the output layer. Neural networks used in deep learning applications often include many hidden layers, thereby increasing the depth of the network. The layers of a neural network are connected in sequence such that the output of the previous layer is provided as the input of the subsequent layer, where the input layer receives the input of the neural network, and the output of the output layer serves as the final output of the neural network. Each layer of a neural network includes one or more nodes (also referred to as processing nodes or neurons), each of which processes input from the previous layer.

Generally, machine learning may roughly include three stages, namely a training stage, a testing stage and an application stage (also referred to as an inference stage). In the training stage, a given model may be trained using a large amount of training data, and parameter values are continuously updated iteratively until the model may obtain consistent inferences from the training data that meet the expected goals. Through training, the model may be thought of as being able to learn associations from inputs to outputs (also referred to as input-to-output mappings) from the training data. The parameter values of the trained model are determined. In the testing stage, test inputs are applied to the trained model to test whether the model may provide the correct output, thereby determining the performance of the model. In the application stage, the model may be used to process the actual input and determine the corresponding output based on the parameter values obtained through training.

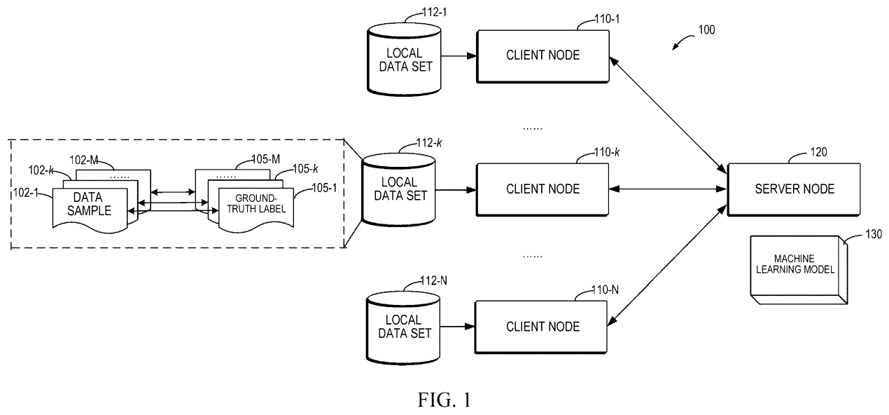

FIG. 1 illustrates a schematic diagram of an example environment 100 in which the embodiments of the present disclosure can be implemented. The environment 100 involves a federated learning environment, which includes N client nodes 110-1, . . . 110-k, . . . 110-N (where N is an integer greater than 1, k=1, 2, . . . N), and a server node 120. The client nodes 110-1, . . . 110-k, . . . 110-N may maintain their respective local datasets 112-1, . . . 112-k, . . . 112-N. For the sake of discussion, the client nodes 110-1, . . . 110-k, . . . 110-N may be collectively or individually referred to as client nodes 110, and the local datasets 112-1, . . . 112-k, . . . 112-N may be collectively or individually referred to as local datasets 112.

In some embodiments, the client node 110 and/or the server node 120 may be implemented at a terminal device or a server. The terminal device may be any type of mobile terminal, fixed terminal, or portable terminal, including mobile phones, desktop computers, laptop computers, notebook computers, netbook computers, tablet computers, media computers, multimedia tablets, personal communication system (PCS) devices, personal navigation devices, personal digital assistants (PDAs), audio/video player, digital cameras/camcorders, positioning devices, television receivers, radio broadcast receivers, electronic book devices, gaming devices, or any combination of the foregoing, including accessories and peripherals of these devices, or any combination thereof. In some embodiments, the terminal device may also be able to support any type of interface to the user (such as “wearable” circuitry, etc.). Servers are various types of computing systems/servers that can provide computing power, including but not limited to mainframes, edge computing nodes, computing devices in cloud environments, and the like.

In federated learning, a client node refers to a node that provides part of data for application training, verification or evaluation of prediction models. The client node may also be referred to as a client, a terminal node, a terminal device, a user equipment, etc. In federated learning, a server node refers to a node that aggregates the results at the client node.

In the example in FIG. 1, assume that N client node 110 jointly participate in the training of a prediction model 130, and collect the intermediate results in the training to the server node 120, so that the server node 120 may update a parameter set of the prediction model 130. The complete set of local data of these client nodes 110 constitute a complete training data set of the prediction model 130. Therefore, according to the federated learning mechanism, the server node 120 may generate a global machine learning model 130.

For the prediction model 130, the local data set 112 at the client node 110 may include data samples and ground-truth labels. FIG. 1 specifically illustrates the local data set 112-k at the client node 110-k, which includes a data sample set and a ground-truth label set. The data sample set includes multiple (M) data samples 102-1, 102-i, . . . 102-M (collectively or individually referred to as data sample 102), and the ground-truth label set includes a corresponding multiple (M) ground-truth labels 105-1, 105-i, . . . 105-M (collectively or individually referred to as ground-truth label 105). Herein, M is an integer greater than 1, i=1, 2, . . . M. Each data sample 102 may be marked shows with a corresponding ground-truth label 105. The data sample 102 may correspond to the input of the prediction model 130, and the ground-truth label 105 indicates the true output of the data sample 102. A ground-truth label is an important part of supervised machine learning.

In the embodiments of the present disclosure, the prediction model 130 may be constructed based on various machine learning or deep learning model architectures, and may be configured to implement various prediction tasks, such as various classification tasks, recommendation tasks, and so on. Accordingly, the prediction model 130 may also be referred to as a recommendation model, a classification model, and the like.

The data sample 102 may include input information related to the specific task of the prediction model 130, and the ground-truth label 105 is related to the expected output of the task. As an example, in a binary classification task, the prediction model 130 may be configured to predict whether the data sample input belongs to a first category or a second category, and the ground-truth label is used to mark that the data sample actually belongs to the first category or the second category. Many practical applications may be classified as such binary tasks, such as the conversion of recommended items (such as clicking, purchasing, registering, or other demand behaviors) in a recommendation task, and so on.

It should be understood that FIG. 1 only illustrates an example of the federated learning environment. According to federated learning algorithms and practical application needs, the environment may also be different. For example, although illustrated as a separate node, in some applications, the server node 120 may also serve as a client node in addition to serving as a central node to provide part of data for model training, evaluating model performance, and so on. The embodiments of the present disclosure are not limited in this respect.

In the training phase of the prediction model 130, there are some mechanisms to protect the local data of each client node 110 from leakage. For example, during the model training, the client node 110 does not need to leak local data samples or label data, but sends gradient data computed based on to the local training data to the server node 120 for the server node 120 to update a parameter set of the prediction model 130.

In some cases, it is also expected to evaluate the performance of the trained prediction model. The evaluation of model performance also requires data, including data samples required for model input and the corresponding label data of data samples. The performance of the prediction model may be measured by one or more performance indicators. Different performance indicators may measure the difference between the predicted output given by the prediction model for the data sample set and the true output indicated by the ground-truth label set from different perspectives. Generally, if the difference between the predicted output given by the prediction model and the true output is small, it means that the performance of the prediction model is better. It can be seen that the performance indicator of the prediction model usually needs to be determined based on the ground-truth label set of the data samples.

As the data supervision system continues to strengthen, the requirements for data privacy protection are becoming increasingly higher. The ground-truth labels of data samples also need to be protected to avoid being leaked. Therefore, it is a challenging task to determine the performance indicator of the prediction model and protect the local label data of the client node from leakage. There is currently no highly effective solution to address this issue.

According to embodiments of the present disclosure, a scheme for evaluating model performance is provided, which is capable of protecting local tag data of a client node. In particular, at the client node, a plurality of predicted classification results corresponding to a plurality of data samples is determined by comparing a plurality of predicted scores to a score threshold, the plurality of predicted scores being output by a machine learning model for the plurality of data samples. The client node determines values of a plurality of metric parameters associated with a predetermined performance indicator of the machine learning model based on differences between the plurality of predicted classification results and a plurality of ground-truth classification results corresponding to the plurality of data samples. The client node applies perturbation to the values of the plurality of metric parameters, to obtain perturbed values of the plurality of metric parameters. The client node sends sending the perturbed values of the plurality of metric parameters to a server node. The server node determines the predetermined performance indicator based on the perturbed values of the plurality of metric parameters received from the respective client nodes.

According to the embodiments of the present disclosure, each client node does not need to expose a local ground-truth label set, and does not need to expose a local prediction classification result (namely, predicted label information), and at the same time, a server node may also calculate values of performance indicators based on feedback information (for example, perturbed values of a plurality of metric parameters) of the client node. In this way, the purpose of privacy protection of the local tag data of client node is achieved while determining the performance indicator of the machine learning model.

Some example embodiments of the present disclosure will be described below with continued reference to the accompanying drawings.

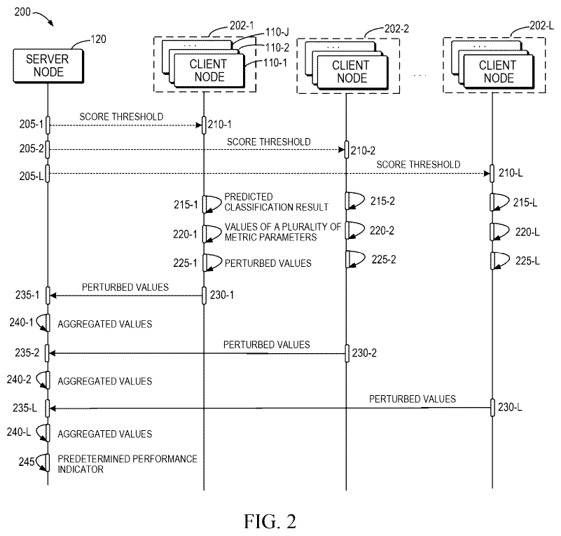

FIG. 2 illustrates a schematic diagram of a signaling flow 200 for evaluating model performance according to some embodiments of the disclosure. Signaling flow 200 relates to a server node 120 and a plurality of client node groups 202-1, 202-2, . . . , 202-L in environment 100. For case of discussion, these client node groups are referred to collectively herein or individually as client node groups, where L is an integer greater than or equal to 1.

The client node group 202 may comprise a plurality of client nodes 110. For example, taking the client node group 202-1 as an example, the client node group 202-1 may comprise client nodes 110-1, 110-2, . . . , 110-J, where J is an integer greater than or equal to 1 and less than or equal to N. It should be understood that signaling flow 200 may relate to any number of server nodes 120 and any number of client node groups 202.

It should be appreciated that each client node group 202 may include any number of client nodes 110. The number of client nodes 110 of each client node group 202 may be the same or different. In some embodiments, the N client nodes 110 may be equally or approximately equally divided into L client node groups 202, with N/L (taking an integer) client nodes 110 being included in each client node group 202.

In embodiments of the present disclosure, assume that the performance of machine learning model 130 is to be evaluated. In some embodiments, machine learning model 130 to be evaluated may be a global machine learning model determined based on a training procedure of federated learning, e.g., client node 110 and server node 120 participate in the training procedure of machine learning model 130. In some embodiments, machine learning model 130 may also be a model obtained in any other manner, and client nodes 110 and server nodes 120 may not participate in the training process of machine learning model 130. The scope of the present disclosure is not limited in this respect.

In some embodiments, server node 120 sends (not shown) machine learning model 130 to client nodes 110 in various client node groups 202. Upon receiving machine learning model 130, the various client nodes 110 may perform subsequent evaluation procedures based on machine learning model 130. In some embodiments, the machine learning model 130 to be evaluated may also be provided to the client nodes 110 in any other suitable manner.

In some embodiments, server node 120 may send the plurality of score thresholds to the client nodes 110 in at least one client node group 202, respectively. For example, server node 120 may randomly generate L score thresholds, and send the L score thresholds to respective client nodes 110 of the L groups of client nodes 202, respectively. Each score threshold is a numerical value between 0 and 1.

In some embodiments, the value of L (i.e., the number of score thresholds or the number of client node groups 202) may be predetermined by server node 120. For example, the value of L may be determined based on the number of client nodes 110. In some embodiments, the value of L may also be determined based on the type of predetermined performance indicator to be determined by server node 120. For example, if the predetermined performance indicator to be determined by the server node 120 is an accuracy rate (ACC) of the prediction result, the server node 120 may determine the value of L to be 1. As another example, if the predetermined performance indicator to be determined by the server node 120 is an area under the curve (AUC) of a subject operating characteristic curve (ROC), the server node 120 may determine a value of L as an integer greater than 1. It should be understood that, in a case that the predetermined performance indicator is the ACC or the AUC of the ROC, the value of L may also be determined as other appropriate integer value. Embodiments of the present disclosure are not limited in this regard.

As shown in FIG. 2, server node 120 may send (205-1) the first score threshold to the client node 110 in its associated client node group 202-1. Similarly, the server node 120 may send (205-2/ . . . /205-L) the second/ . . . /Lth score threshold to the client node 110 in the client node group 202-2/ . . . /202-L with which it is associated.

The client nodes 110 in each client node group 202 receive (210-1/210-2/ . . . /210-L) to their respective score threshold.

Taking a client node 110 in the client node group 202-1 as an example, the client node 110 may apply each data sample 102 to the machine learning model 130 as an input of the model, and obtain a predicted score output by the machine learning model 130. The client node 110 determines (215-1) a plurality of predicted classification results corresponding to the plurality of data samples 102 by comparing the plurality of predicted scores output by the machine learning model 130 for the plurality of data samples 102 to a score threshold. The plurality of prediction classification results indicate that the plurality of data samples 102 are predicted to belong to the first category or the second category, respectively.

In embodiments of the present disclosure, particular attention is paid to the performance indicators of machine learning models that achieve the binary classification task. Each prediction score may indicate a prediction probability that the corresponding data sample 102 belongs to the first category or the second category. The two categories may be configured according to actual task requirements.

A value range of the predicted score output by the machine learning model 130 may be set randomly, for example, the predicted score may be a value in a certain continuous value range (for example, a value between 0 and 1), or may be a value in a plurality of discrete values (for example, may be one of discrete values such as 0, 1, 2, 3, 4, 5). In some examples, a higher prediction score may indicate a higher prediction probability of the data samples 102 belonging to the first category and a lower prediction probability of belonging to the second category. Of course, an opposite arrangement is also possible, e.g., a higher prediction score may indicate a higher prediction probability of the data samples 102 belonging to the second category and a lower prediction probability of belonging to the first category.

In some embodiments, if predicted score for a data sample 102 from the machine learning model 130 exceeds a score threshold, the client node 110 may determine the predicted classification results corresponding to the data sample 102 as indicating that the data sample is of a first category. Conversely, if predicted score for a data sample 102 from the machine learning model 130 does not exceed the score threshold, the client node 110 may determine the predicted classification result corresponding to the data sample 102 as indicating that the data sample is of a second category.

In some embodiments, each data sample 102 has a ground-truth label 105 that labels whether the corresponding data sample 102 belongs to a first category or a second category. Hereinafter, for case of discussion, data samples belonging to a first category will sometimes be referred to as positive samples, positive examples, or positive classes of samples, and data samples belonging to a second category will sometimes be referred to as negative samples, negative examples, or negative classes of samples. In some embodiments, each ground-truth label 105 may have one of two values for indicating a first category or a second category, respectively. In some embodiments below, for case of discussion, the value of the ground-truth label 105 corresponding to the first category may be set to “1”, which indicates that the corresponding data sample 102 belongs to the first category and is a positive sample. In addition, the value of the ground-truth tag 105 corresponding to the second category may be set to “0”, which indicates that the corresponding data samples 102 belong to the second category and are negative samples.

It should be understood that the first category and the second category may be any category in the two category problems. By taking the binary classification problem of determining whether the content of the image is a cat as an example, the first category may indicate that the content of the image is a cat, and the second category may indicate that the content of the image is a non-cat. Taking evaluating the quality of an article as an example, the first category may indicate that the quality amount of the article meets the standard, and the second category may indicate that the quality of the article does not meet the standard. It should be understood that the above-listed two classification problems are merely exemplary, and the evaluating model performance method described herein is applicable to various two classification problems. Embodiments of the present disclosure are not limited in this regard. In some example embodiments below, for ease of discussion, the description is primarily given by taking image classification as an example, but it should be understood that it does not imply that those embodiments can only be applied to the above two classification problem.

The client node 110 in the client node group 202-1 determines (220-1) values of a plurality of metric parameters associated with predetermined performance indicators of the machine learning model 130 based on differences between a plurality of predicted classification results and a plurality of ground-truth classification results corresponding to the plurality of data samples 102. The plurality of ground-truth classification results may be respectively labeled by a plurality of ground-truth labels of the plurality of data samples 102 to indicate whether the plurality of data samples 102 belong to a first category or a second category.

In some embodiments, the plurality of metric parameters may include a first number of first-type data samples of the plurality of data samples 102. The prediction classification result and the ground-truth classification result corresponding to the first-type data sample both indicate the first category. For example, for a data sample 102, if a ground-truth classification result (or a ground-truth tag 105) of the data sample 102 indicates that the data sample 102 belongs to a first category (for example, an image of a cat), and a predicted classification result predicted by the machine learning model 130 also indicates that the data sample 102 belongs to the first category, then the data sample 102 belongs to a first category of data samples, and is also referred to as true positive (TP) samples.

In some embodiments, the plurality of metric parameters may include a second number of second-type data samples among the plurality of data samples 102. The prediction classification result and the ground-truth classification result corresponding to the second type of data sample both indicate the second category. For example, for a data sample 102, if the ground-truth classification result (or ground-truth tag 105) of the data sample 102 indicates that the data sample 102 belongs to a second category (e.g., does not belong to a cat's image), and the predicted classification result predicted by the machine learning model 130 also indicates that the data sample 102 belongs to a second category, then the data sample 102 belongs to a second category of data samples, and is also referred as true negative (TN) samples.

In some embodiments, the plurality of metric parameters may include a third number of third-type data samples of the plurality of data samples 102. The prediction classification result corresponding to the third-type data samples indicates the first category and the corresponding ground-truth classification result indicates the second category. For example, for a data sample 102, if the ground-truth classification result (or ground-truth tag 105) of the data sample 102 indicates that the data sample 102 belongs to a second category (e.g., an image that does not belong to a cat), and prediction classification results predicted by the machine learning model 130 indicate that the data samples 102 belong to a first category (e.g., if the image is an image of a cat, the data sample 102 is a third-type of data sample, which is also referred to as a false positive FP sample.

In some embodiments, the plurality of metric parameters may include a fourth number of fourth-type data samples of the plurality of data samples. The prediction classification result corresponding to the fourth-type of data sample indicates the second category, and the corresponding ground-truth classification result indicates the first category. For example, for a data sample 102, if a ground-truth classification result (or a ground-truth tag 105) indicates that the data sample 102 belongs to a first category (e.g., belongs to an image of a cat), while a predicted classification result predicted by the machine learning model 130 indicates that the data sample 102 belongs to a second category (e.g., does not belong to an image of a cat), then the data sample 102 belongs to a fourth-type of data samples, also known as false negative samples (FN).

The four results described above are summarized in Table 1 below.

TABLE 1

Ground-Truth Classification Result

| | | 1 | 0 |
|---|---|---|---|
| Predicted | 1 | TP | FP |
| Classification | 0 | FN | TN |
| Result | | | |

Examples of a plurality of metric parameters are cited above by taking the first number (number of TPs), the second number (number of TNs), the third number (number of FPs), and the fourth number (number of FNs) as examples. It should be understood that the client node 110 may determine (220-1) the value of the at least one metric parameter above, based on differences between the plurality of predicted classification results and the plurality of ground-truth classification results corresponding to the plurality of data samples 102. Alternatively, the client node 110 may determine 220-1 the value of the number of TPs, TNs, FPs, and FNs described above, based on the differences described above. Additionally, the client node 110 may also determine values for other additional metric parameters.

In examples where the client node 110 determines the values of TP, TN, FP, and FN described above, the client node 110 may represent the four values as a quad, i.e., (FP, FN, TP, TN). Additionally, in some embodiments, the four values described above may be stored with the score threshold of the client node 110, for example indicated as (k_i, FP, FN, TP, TN), where k_i represents the score threshold of the i^{th} client node group.

In other words, the client node 110 of each client node group 202 in the plurality of client node groups 202 is different from the client nodes of other client node groups 202. In this way, each client node 110 receives only one score threshold, and each client node 110 determines the value of each metric parameter based only on one score threshold. In this way, leakage of information, such as prediction classification results or prediction classification tags, etc., of the client nodes 110 can be avoided.

The client node 110 in the client node group 202-1 applies a perturbation to the values of the plurality of metric parameters to obtain (225-1) perturbed values for the plurality of metric parameters. For example, for at least one number of TPs, TNs, FPs, and FNs, the client node 110 may add a random perturbation to one or more values of the TPs, TNs, FPs, and FNs by, for example, a Gaussian mechanism or a Laplace mechanism.

FIG. 3 shows a flowchart of a process 300 of applying perturbations according to some embodiments of the disclosure. Process 300 may be implemented at the client node 110.

In particular, at block 310, the client node 110 is configured to determine a sensitivity value related to the perturbation. For example, the sensitivity Δ may be set to 1. That is, every time a label of one data sample 102 is changed, the influence on the statistics amount is at most 1. Alternatively, the sensitivity value may also be set to another appropriate value.

At block 320, the client node 110 is configured to determine a random perturbation distribution based on the sensitivity value Δ and the signature differential privacy mechanism.

The random response mechanism is one of differential privacy (DP) mechanisms. For a better understanding of embodiments of the present disclosure, the differential privacy and random response mechanism will first be briefly introduced below.

Assuming that ϵ, δ is a number greater than or equal to 0, i.e., ϵ, δ∈ [symbol] ≥0, and [symbol] is a random mechanism (random algorithm). By random mechanism, it is meant that for a particular input, the output of the mechanism is not a fixed value, but rather follows a certain distribution. For a random mechanism [symbol] , the random mechanism [symbol] can be considered to have-differential privacy (ϵ, δ) if the following is satisfied: for any two adjacent training datasets D, D′, and for any subset S of possible outputs of [symbol] , there is:

$$Pr [ ℳ ( D ) ∈ S ] \leq {e}^{ϵ} \cdot Pr [ ℳ ( {D}^{′} ) ∈ S ] + δ \qquad ( 1 )$$

Further, the random mechanism [symbol] may also be considered to have ϵ-differential privacy (ϵ-DP) if δ=0.

In the differential privacy mechanism, for a random mechanism with differential privacy or differential privacy, it is expected that the distribution of two outputs obtained after respectively acting on two adjacent datasets is difficult to distinguish. In this way, by observing the output result, the observer can hardly perceive a tiny change in the input data set of the algorithm, thereby achieving the purpose of privacy protection. If the random mechanism [symbol] acts on any adjacent data set and the probability of obtaining a specific output S is almost the same, it is considered that the algorithm has difficulty in achieving the effect of differential privacy.

In embodiments herein, attention is focused on differential privacy for tags of data samples, and the tags indicate two classification results. Thus, following the setting of the differential privacy, the label differential privacy can be defined. In particular, assuming that ϵ, δ is a number greater than or equal to 0, i.e., ϵ, δ∈ [symbol] ≥0, and [symbol] is a random mechanism (random algorithm). A random mechanism [symbol] can be considered to have a (ϵ, δ)-label differential privacy if, for any two adjacent training datasets D, D′, they differ only in that the labels of a single data sample are different, and for any subset S of possible outputs of [symbol] , there are:

$$Pr [ ℳ ( D ) ∈ S ] \leq {e}^{ϵ} \cdot Pr [ ℳ ( {D}^{′} ) ∈ S ] + δ \text{?} \qquad ( 2 )$$

$$\text{?} \text{indicates text missing or illegible when filed}$$

In addition, if δ=0, the random mechanism [symbol] can also be considered to have ϵ-differential privacy (ϵ-DP), that is, it is expected that after changing the label of a data sample, the distribution of output results from the random mechanism [symbol] is still small, making it difficult for an observer to perceive changes to the label.

The random response mechanism is a random mechanism applied for the purpose of differential privacy protection. The random response mechanism is located as follows: assuming ϵ is a parameter, and [symbol] ∈[0, 1] is a known value of the ground-truth label in the random response mechanism. If for a value [symbol] of a ground-truth tag, the random response mechanism derives a random value [symbol] from the following probability distribution:

$$Pr [ y \text{?} = \hat{y} ] = \{ \begin{matrix}\frac{\text{?}}{1 + \text{?}} & for y = \hat{y ,} \\ \frac{1}{1 + \text{?}} & otherwise\end{matrix} \qquad ( 3 )$$

$$\text{?} \text{indicates text missing or illegible when filed}$$

That is to say, after the random response mechanism is applied, the random value [symbol] has a certain probability of being equal to [symbol] , and also has a certain probability of not being equal to [symbol] . The above random response mechanism is considered to have tag differential privacy (-tag differential privacy) when δ=0, because:

$$\frac{Pr [ \tilde{y} = 1 \vert y = 1 ]}{Pr [ \tilde{y} = 1 \vert y = 0 ]} = \frac{\frac{\text{?}}{1 + \text{?}}}{\frac{1}{1 + \text{?}}} = {e}^{ϵ} = \frac{Pr [ \tilde{y} = 0 \vert y = 0 ]}{Pr [ \tilde{y} = 0 \vert y = 1 ]} \qquad ( 4 )$$

$$\text{?} \text{indicates text missing or illegible when filed}$$

That is, the random response mechanism will satisfy ϵ-differential privacy.

Differentiated privacy and random response mechanisms are discussed above. Through the random response mechanism, the client node 110 may add random perturbations to values of a plurality of metric parameters to avoid the server node 120 acquiring privacy (e.g., predicted label information, etc.) at the client node 110.

In some embodiments, the tag differential privacy mechanism may be a Gaussian mechanism. The standard deviation σ of the random perturbation distribution (ϵ, δ)-DP of the Gaussian mechanism (i.e., the standard error of the added noise) may be calculated as Equation (5) below.

$$σ - Δ \sqrt{2 log ( 1.25 / δ )} / ϵ \qquad ( 5 )$$

where Δ represents a sensitivity value, δ and ϵ is any value between 0 and 1 (excluding 0 and 1).

Alternatively, in some embodiments, the tag differential privacy mechanism may be a Laplace mechanism. The random perturbation distribution of the Laplace mechanism satisfies (ϵ, 0)-DP, the scale of the Laplace distribution is b=Δ/ϵ, such that the standard deviation σ of the random noise added may be calculated as Formula (6) below.

$$σ = \sqrt{2 b} = \sqrt{2} Δ / ϵ \qquad ( 6 )$$

It should be understood that the Gaussian mechanism and the Laplace mechanism listed above are merely illustrative and not restrictive. Embodiments of the present disclosure may use other suitable tag differential privacy mechanisms to determine random perturbation distributions. Embodiments of the present disclosure are not limited in this regard.

At block 330, the client node 110 is configured to apply a perturbation to at least a number based on the random perturbation distribution. For example, in an example in which the client node 110 determines the four values TP, TN, FP, and FN, the client node 110 may apply random perturbations to the four values to obtain perturbed values (FP′, FN′, TP′, TN′), or may also be represented as (k-i, FP′, FN′, TP′, TN′). Alternatively, in some embodiments, the client node 110 may apply a random perturbation to one or more of the above four values.

By imposing perturbations on the values of the metric parameters, it is possible to prevent the information of the client nodes 110, in particular the canonical labeling information, from being leaked. Specifically, this way of applying perturbations can avoid the server node 120 from extrapolating the predicted tag of the client node 110. For example, if no perturbation is imposed on the values of the metric parameters, when TP/(TP+FP) is too large, the server node may determine that samples larger than threshold k_i are positive samples. For another example, if no perturbation is imposed on the value of the metric parameter, when FN/(FN+TN) is too large, the server node may determine that samples smaller than the threshold k_i are negative samples. By imposing a perturbation on the values of the metric parameters, this and other potential information leakage scenarios can be avoided.

With continued reference to FIG. 2, the client node 110 in the client node group 202-1 sends (230-1) the perturbed values of the plurality of metric parameters to the server node 120 for use in determining the predetermined performance indicator at the server node 120. “Perturbation” is also sometimes referred to herein as noise, interference, etc.

In some embodiments, each client node 110 in the client node group 202-1 may send a quadruple (FP′, FN′, TP′, TN′) or (k_i, FP′, FN′, TP′, TN′) to the server node 120. Alternatively, the client node 110 in the client node group 202-1 may send one or more of the four perturbed values described above to the server node 120. The process of the server node 120 determining the predetermined performance indicator will be described below.

Similarly, the client node 110 in the client node group 202-2/ . . . /202-L determines the plurality of predicted classification results corresponding to the plurality of data samples 102 by comparing the plurality of predicted scores output by the machine learning model 130 for the plurality of data samples 102 to a score threshold. The client node 110 in the client node group 202-2/ . . . /202-L determines (220-2/ . . . /220-L) values of a plurality of metric parameters associated with a predetermined performance indicator of the machine learning model 130 based on differences between the plurality of predicted classification results and the plurality of ground-truth classification results corresponding to the plurality of data samples 102. The client node 110 in the client node group 202-2/ . . . /202-L applies a perturbation to the values of the plurality of metric parameters to obtain perturbed values of the plurality of metric parameters (225-2/ . . . /225-L). The client node 110 in the client node group 202-2/ . . . /202-L sends (230-2/ . . . /230-L) the perturbed values of the plurality of metric parameters to the server node 120 for use in determining a predetermined performance indicator at the server node 120. The foregoing process is similar to the corresponding process of the client node group 202-1, and is not further described herein.

At the server node 120, perturbed values of a plurality of metric parameters associated with a predetermined performance indicator of the machine learning model 130 are received (235-1, or also 235-2/ . . . /235-L, collectively 235) from at least one client node group 202-1 (or 202-2/ . . . /202-L), respectively. For example, server node 120 may receive 235 a quadruple (FP′, FN′, TP′, TN′) or (k_i, FP′, FN′, TP′, TN′) from at least one client node group 202, respectively. Alternatively, server node 120 may receive (235) one or more of the four perturbed values described above, which may depend on the performance indicator to be calculated.

TP′ represents a first number of perturbations of a first type of data sample of the plurality of data samples 102 at a given client node 110, wherein the first type of data sample is labeled as a first category by a ground-truth labeling and predicted to be the first category by the machine learning model 130. TN′ represents a second number of perturbations of a second type of data sample in the plurality of data samples 102, where the second type of data sample is labeled as a second category by the ground-truth labeling and is also predicted to the second category by the model. FP′ represents a third number of perturbations of a third category of data samples in the plurality of data samples 102, where the third category of data samples is annotated as a second category and predicted as a first category. FN′ denotes a fourth number of perturbations of a fourth category of data samples, of the plurality of data samples 102, wherein the fourth category of data samples is annotated as a first category and predicted as a second category.

For each client node group of the at least one client node group 202, the server node 120 aggregates the perturbed values of the plurality of metric parameters of the client nodes 110 from the client node group according to the metric parameters to obtain an aggregation value of the plurality of metric parameters respectively corresponding to the at least one client node group 202. For example, the server node 120 aggregates (240-1) the perturbed values (FP′, FN′, TP′, TN′) of the plurality of metric parameters from the client node 110 of the client node group 202-1 according to the metric parameters to obtain an aggregated value of the plurality of metric parameters corresponding to the client node group 202-1. Similarly, the server node 120 aggregates (240-2/ . . . /240-L) the perturbed values (FP′, FN′, TP′, TN′) of the plurality of metric parameters from the client nodes 110 of the client node group 202-2/ . . . /202-L according to the metric parameters to obtain the aggregate values of the plurality of metric parameters respectively corresponding to the client node group 202-2/ . . . /202-L.

In some embodiments, for each client node group 202, the server node 120 may compute the aggregate values TPR (true sample rate) and FPR (false positive sample rate) for the plurality of metric parameters corresponding to that client node group 202 based on Equations (7) and (8) below. TPR indicates a proportion that is correctly determined to be positive in a sample that is actually positive (positive sample), and FPR indicates a proportion that is incorrectly determined to be positive in a sample that is actually negative (negative sample).

$$TPR = {TP}^{′} / ( {TP}^{′} + {FN}^{′} ) \qquad ( 7 )$$

$$FPR = {FP}^{′} / ( {FP}^{′} + {TN}^{′} ) \qquad ( 8 )$$

It should be appreciated that the aggregate values TPR and FPR described above are merely exemplary and not limiting. In some embodiments, server node 120 may use other methods to derive an aggregate value for a plurality of metric parameters corresponding to client node group 202.

The server node 120 determines 245 values of the predetermined performance indicator based on the plurality of score thresholds respectively associated with the at least one client node group 202 and the aggregate values of the plurality of metric parameters respectively corresponding to the at least one client node group 202.

In some embodiments, the predetermined performance indicator comprises at least the area under the curve (AUC) of the receiver operator characteristic curve (ROC). Server node 120 may determine an ROC for machine learning model 130 based on at least one score threshold and an aggregate value of a plurality of metric parameters.

In some embodiments, the value of L (i.e., the number of score thresholds or the number of client node groups 202) may be greater than 1. In other words, at least one group may include a plurality of groups and at least one score threshold includes a plurality of score thresholds. The server node 120 may calculate coordinates points for a number of (FPR, TPR) pairs based on each threshold score, and form these points into a line to fit the ROC curve of the machine learning model 130.

The server node 120, in turn, can determine the AUC of the ROC, which, by definition, refers to the area under the ROC curve. In some embodiments, the AUC may be calculated by calculating the area under the ROC curve with an approximate algorithm according to the definition of the AUC.

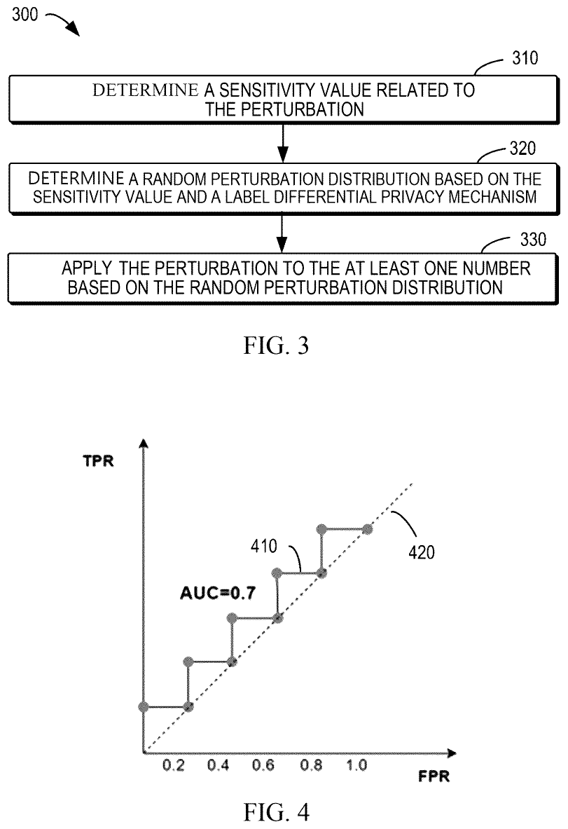

FIG. 4 shows a schematic diagram of an ROC curve 410 according to some embodiments of the disclosure. ROC curve 410 results from calculating the coordinate point plot of a number of pairs of (FPR, TPR) as a function of a number of threshold scores (in this example, the value of L is greater than 1). In the example of FIG. 4, the plurality of coordinate points are (0, 0), (0, 0.2), (0.2, 0.2), (0.2, 0.4), (0.4, 0.4), (0.4, 0.6), (0.6, 0.6), (0.6, 0.8), (0.8, 0.8), (0.8, 1) and (1, 1). Also shown in FIG. 4 is a graph 420 that divides the ROC plane into two sections. ROC curve 410 can be used to determine that the ROC curve has an AUC of 0.7. Alternatively, the area between ROC curve 410 and curve 420 may be determined to be 0.2, and the AUC for ROC curve 410 may be determined to be 0.7.

It should be understood that the ROC curve 410 depicted in FIG. 4 is merely illustrative and that the coordinate values for the various coordinate points in FIG. 4 are for illustration purposes only and are not limiting. The server node 120 may determine coordinate values of other values, and may draw an ROC curve of other shapes.

By dividing the client nodes 110 into two or more groups, and by calculating coordinate points of a plurality of (FPR, TPR) pairs according to a plurality of threshold scores to obtain the AUC of the ROC, the result of evaluating model performance can be made more accurate.

Additionally or alternatively, the AUC can also be determined from a probabilistic point of view when calculating the AUC. The AUC can be considered to be the probability of a positive sample and a negative sample being chosen at random, and the probability of a machine learning model giving a positive sample a predicted score higher than a negative sample. That is to say, in the data sample set, a positive sample and a negative sample are combined in pairs to form a positive sample pair, wherein the prediction score of the positive sample is greater than the ratio of the prediction scores of the negative samples. If the model is able to output a higher predicted score for more positive samples than negative samples, the AUC can be considered higher and the model performs better. The AUC is between 0.5 and 1. The closer the AUC is to 1, the better the performance of the model is. In this example, the server node 120 may determine the AUC from a probabilistic perspective based on a score threshold corresponding to at least one client node group 202 and an aggregate value of a plurality of metric parameters. In this example, the value of L (i.e., the number of score thresholds or the number of client node groups 202) may be 1, and may also be an integer greater than 1.

In the AUC computation described above, the values of the respective metric parameters required need to be determined based on the tag data of the data samples 102.

Alternatively or additionally, in some embodiments, the predetermined performance indicator may include an ACC of predicted results. In this example, for each client node group 202, the server node 120 may determine (TP′+TN′) and (TP′+FP′+FN′+TN′), respectively, as aggregate values of a plurality of metric parameters corresponding to the client node group 202. The server node 120, in turn, may determine the value of the ACC using Equation (9) below based on the aggregate values described above.

$$ACC = ( TP ' + TN ' ) / ( TP ' + FP ' + FN ' + TN ' ) \qquad ( 9 )$$

In addition to AUC and ACC, the performance indicators of machine learning model 130 may also include precision, which is denoted as Precision=TP′/TP′+FP′. Performance indicators of the machine learning model 130 may also include an accuracy indication, a probability of being labeled as a positive sample by a label in a subset of data samples predicted to be positive samples. Performance indicators of machine learning model 130 may also include recall rate (Recall), which is represented as Recall=TP′/TP′+FN′, the probability that a positive sample is predicted. Performance indicators of machine learning model 130 may also include a P-R curve with recall rate as a horizontal axis and precision as a vertical axis. The closer the P-R curve is to the upper right corner, the better the performance of the model is indicated. The area under the curve is called the AP score (Average Precision Score).

It should be understood that the performance indicators such as AUC of ROC listed above are merely exemplary, and do not limit the innovation. Examples of performance indicators used by the present disclosure include, but are not limited to, AUC of ROC, accuracy rate, error-rate, accuracy rate, recall rate, AP score, etc.

In the above manner, the server node 120 may determine the predetermined performance indicator based on the perturbed values of the plurality of metric parameters received from at least one client node group, so as to perform evaluating model performance. In this way, the client node does not need to expose a local ground-truth label set and does not need to expose a local prediction classification result (namely, predicted label information), and at the same time, the server node can also calculate the value of the performance index based on feedback information (e.g., perturbed values of a plurality of metric parameters) of the client node. In this way, the purpose of privacy protection of the client node local tag data is achieved while determining the performance indicator of the machine learning model.

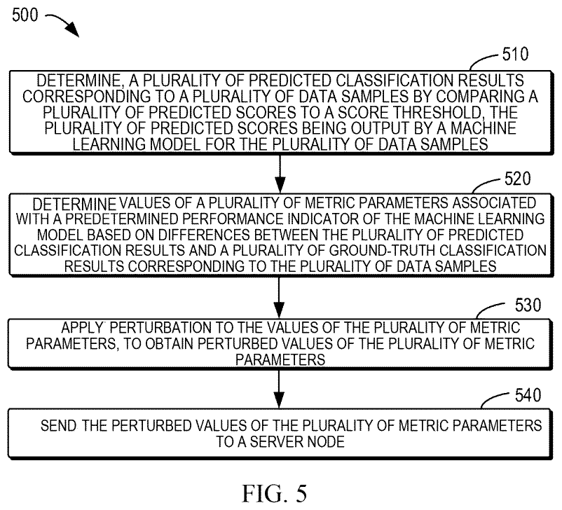

FIG. 5 illustrates a flow diagram of a process 500 for evaluating model performance, according to some embodiments of the disclosure. Process 500 may be implemented at a client node 110.

At block 510, the client node 110 determines a plurality of predicted classification results corresponding to the plurality of data samples 102 by comparing a plurality of predicted scores to a score threshold, the plurality of predicted scores being output by the machine learning model 130 for the plurality of data samples 102. The plurality of prediction classification results indicate that the plurality of data samples 102 are predicted to belong to a first category or a second category, respectively. In some embodiments, process 500 further includes receiving the score threshold from server node 120. Client node 110 may determine a plurality of predicted classification results corresponding to the plurality of data samples 102 by comparing the plurality of predicted scores to the score threshold received from server node 120, the plurality of predicted scores being output by machine learning model 130 for the plurality of data samples 102.

At block 520, the client node 110 determines values of a plurality of metric parameters associated with a predetermined performance indicator of the machine learning model 130 based on differences between the plurality of predicted classification results and a plurality of ground-truth classification results corresponding to the plurality of data samples 102.

In some embodiments, in order to determine the values of the plurality of metric parameters, the client node 110 may determine, based on the differences, at least one of the following: a first number of first-type data samples among the plurality of data samples, a predicted classification result and a ground-truth classification result corresponding to a first-type data sample both indicating the first category; a second number of second-type data samples among the plurality of data samples, a predicted classification result and a ground-truth classification result corresponding to a second-type data sample both indicating the second category; a third number of third-type data samples among the plurality of data samples, a predicted classification result corresponding to a third-type data sample indicating the first category and a ground-truth classification result corresponding to the third-type data sample indicating the second category; or a fourth number of fourth-type data samples among the plurality of data samples, a predicted classification result corresponding to a fourth-type data sample indicating the second category, and a ground-truth classification result corresponding to the fourth-type data sample indicating the first category.

At block 530, the client node 110 applies perturbation to the values of the plurality of metric parameters, to obtain perturbed values of the plurality of metric parameters. For example, to the perturbation to the values of the plurality of metric parameters, the client node 110 may, for at least one of the first, the second, the third, and the fourth numbers, apply perturbation to the at least one number by the following: determining a sensitivity value related to the perturbation; determining a random perturbation distribution based on the sensitivity value and a label differential privacy mechanism; and applying the perturbation to the at least one number based on the random perturbation distribution.

At block 540, the client node 110 sends the perturbed values of the plurality of metric parameters to the server node 120 for use in determining a predetermined performance indicator at the server node 120. For example, the predetermined performance indicator comprises at least the area under the curve (AUC) of the receiver operator characteristic curve (ROC).

FIG. 6 illustrates a flow diagram of a process 600 for evaluating model performance at a server node 120, according to some embodiments of the present disclosure. Process 600 may be implemented at a server node 120.

At block 610, the server node 110 receives, from client nodes 110 of at least one group, perturbed values of a plurality of metric parameters from at least one group of client nodes associated with a predetermined performance indicator of a machine learning model 130, respectively. In some embodiments, each group of client nodes 110 in at least one group is distinct from other groups of client nodes 110. In some embodiments, the process 600 further includes sending the at least one score threshold to client nodes 110 in the respective associated group.

In some embodiments, for a given client node 110, the perturbed values of the plurality of metric parameters comprise at least one of: a first perturbed number of a first-type of data sample among the plurality of data samples at the given client node 110, a first-type data sample being labeled as a first category and predicted as the first category; a second perturbed number of second-type data samples among the plurality of data samples, a second-type data sample being labeled as a second category and predicted as the second category; a third perturbed number of third-type data samples among the plurality of data samples, a third-type data sample being labeled as the second category but predicted as the first category; and a fourth perturbed number of fourth-type data samples among the plurality of data samples, a fourth-type data sample being labeled as the first category but predicted as the second category. The above predicting is based on a comparison between the predicted score output by machine learning model 130 and a score threshold associated with a group where the given client node 110 is located.

At block 620, the server node 110 aggregates, for each of the at least one group of the client nodes 110, the perturbed values of the plurality of metric parameters from the group of client nodes in a metric parameter-wise way, to obtain aggregated values of the plurality of metric parameters respectively corresponding to the at least one group.

At block 630, the server node 110 determines a value of the predetermined performance indicator based on at least one score threshold value respectively associated with the at least one group, and the aggregated values of the plurality of metric parameters respectively corresponding to the at least one group. In some embodiments, the at least one group comprises a plurality of groups and the at least one score threshold comprises a plurality of score thresholds. In such an example, to determine the value of the predetermined performance indicator, server node 120 may determine a receiver operating characteristic (ROC) curve of the machine learning model 130 based on the plurality of score thresholds and the aggregated values of the plurality of metric parameters; and determine an area under curve (AUC) of the ROC.

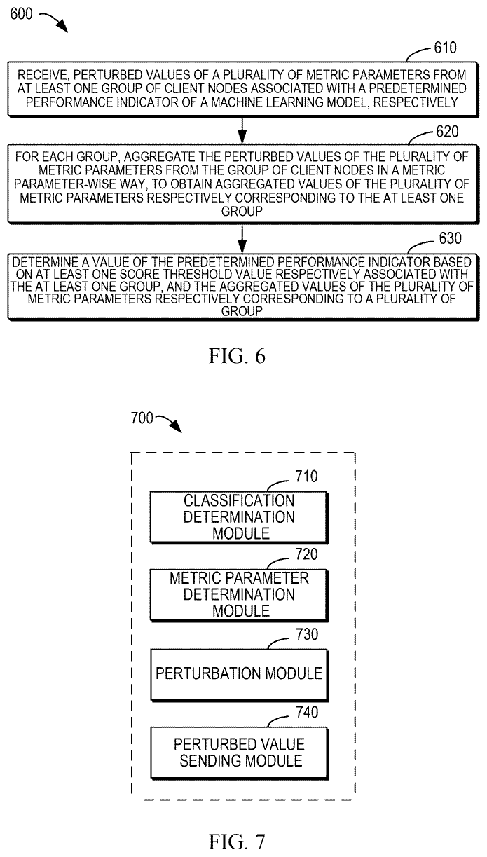

FIG. 7 illustrates a block diagram of an apparatus 700 for evaluating model performance at a client node, according to some embodiments of the disclosure. The apparatus 700 may be implemented as or included in a client node 110. The various modules/components in the apparatus 700 may be implemented by hardware, software, firmware, or any combination thereof.

As shown, the apparatus 700 includes a classification determination module 710 configured to determine a plurality of predicted classification results corresponding to a plurality of data samples 102 by comparing a plurality of predicted scores to a score threshold, the plurality of predicted scores being output by the machine learning model 130 for the plurality of data samples 102. The plurality of prediction classification results indicate that the plurality of data samples 102 are predicted to belong to a first category or a second category, respectively. In some embodiments, apparatus 700 further comprises a receiving module configured to receive the score threshold from the server node 120. The apparatus 700 may determine a plurality of predicted classification results corresponding to the plurality of data samples 102 by comparing the plurality of predicted scores to the score threshold received from the server node 120, the plurality of predicted scores being output by the machine learning model 130 for the plurality of data samples 102.

The apparatus 700 further comprises a metric parameter determination module 720 configured to determine values of a plurality of metric parameters associated with a predetermined performance indicator of the machine learning model 130 based on differences between the plurality of predicted classification results and a plurality of ground-truth classification results corresponding to the plurality of data samples 102.

In some embodiments, the metric parameter determination module 720 is configured to determine, based on the differences, at least one of: a first number of first-type data samples among the plurality of data samples, a predicted classification result and a ground-truth classification result corresponding to a first-type data sample both indicating the first category; a second number of second-type data samples among the plurality of data samples, a predicted classification result and a ground-truth classification result corresponding to a second-type data sample both indicating the second category; a third number of third-type data samples among the plurality of data samples, a predicted classification result corresponding to a third-type data sample indicating the first category and a ground-truth classification result corresponding to the third-type data sample indicating the second category; and a fourth number of fourth-type data samples among the plurality of data samples, a predicted classification result corresponding to a fourth-type data sample indicating the second category, and a ground-truth classification result corresponding to the fourth-type data sample indicating the first category.

The apparatus 700 further comprises a perturbation module 730 configured to apply perturbation to the values of the plurality of metric parameters, to obtain perturbed values of the plurality of metric parameters. For example, the perturbation module 730 may be configured to apply a perturbation to at least one of the first number, the second number, the third number, and the fourth number by: determining a sensitivity value related to the perturbation; determining a random perturbation distribution based on the sensitivity value and a label differential privacy mechanism; and applying the perturbation to the at least one number based on the random perturbation distribution.

The apparatus 700 further comprises a perturbed value sending module 740 configured to send perturbed values of the plurality of metric parameters to a server node 120, so as to determine a pre-determined performance indicator at the server node 120. For example, the predetermined performance indicator comprises at least the area under the curve (AUC) of the receiver operating characteristic (ROC) curve.

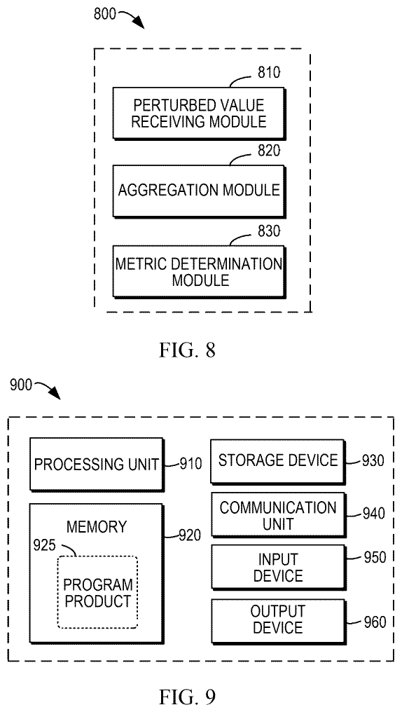

FIG. 8 illustrates a block diagram of an apparatus 800 for evaluating model performance at a server node according to some embodiments of the disclosure. The apparatus 800 may be implemented as or included in a server node 120. The various modules/components in the apparatus 800 may be implemented by hardware, software, firmware, or any combination thereof.

As illustrated, apparatus 800 includes a perturbed value receiving module 810 configured to receive perturbed values of a plurality of metric parameters from at least one group of client nodes 110 associated with a predetermined performance indicator of a machine learning model 130, respectively. In some embodiments, each group of client nodes 110 in at least one group is distinct from other groups of client nodes 110. In some embodiments, apparatus 800 may further comprise a sending module configured to send the at least one score threshold to the client nodes 110 in the respective associated group.

In some embodiments, for a given client node 110, the perturbed values of the plurality of metric parameters comprise at least one of the following: a first perturbed number of first-type data samples among a plurality of data samples at the given client node 110, a first-type data sample being labeled as a first category and predicted as the first category; a second perturbed number of second-type data samples among the plurality of data samples, a second-type data sample being labeled as a second category and predicted as the second category; a third perturbed number of third-type data samples among the plurality of data samples, a third-type data sample being labeled as the second category but predicted as the first category; and a fourth perturbed number of fourth-type data samples among the plurality of data samples, a fourth-type data sample being labeled as the first category but predicted as the second category. The above predicting is based on a comparison between a predicted score output by the machine learning model 130 and a score threshold associated with a group where the given client node 110 is located.

The apparatus 800 further comprises an aggregation module 820, configured to aggregate, for each of the at least one group, the perturbed values of the plurality of metric parameters from the group of client nodes 110 in a metric parameter-wise way, to obtain aggregated values of the plurality of metric parameters respectively corresponding to the at least one group.

The apparatus 800 further comprises a metric determination module 830 configured to determine a value of the predetermined performance indicator based on at least one score threshold value respectively associated with the at least one group, and the aggregated values of the plurality of metric parameters respectively corresponding to the at least one group. In some embodiments, the at least one group comprises a plurality of groups and the at least one score threshold comprises a plurality of score threshold values. In such embodiments, the metric determination module 830 comprises: an operating characteristic (ROC) curve determination module configured to determine a receiver operating characteristic (ROC) curve of the machine learning model 130 based on the plurality of score thresholds and the aggregated values of the plurality of metric parameters. The indicator determination module 830 also comprises an area under curve (AUC) determination module configured to determine an area under curve (AUC) of the ROC.

FIG. 9 illustrates a block diagram of a computing device/system 900 capable of implementing one or more embodiments of the present disclosure. It should be understood that the computing device/system 900 shown in FIG. 9 is only illustrative and should not constitute any limitation on the functionality and scope of the embodiments described herein. The computing device/system 900 shown in FIG. 9 may be used to implement the client node 110 or server node 120 of FIG. 1.

As shown in FIG. 9, the computing device/system 900 is in the form of a general-purpose computing device. The components of computing device/system 900 may include, but are not limited to, one or more processors or processing units 910, a memory 920, a storage device 930, one or more communication units 940, one or more input devices 950, and one or more output devices 960. The processing unit 910 may be an actual or virtual processor and may execute various processes based on the programs stored in the memory 920. In a multiprocessor system, multiple processing units execute computer executable instructions in parallel to improve the parallel processing capability of the computing device/system 900.

The computing device/system 900 typically includes multiple computer storage medium. Such medium may be any available medium that may be accessed by the computing devices/systems 900, including but not limited to volatile and non-volatile medium, removable and non-removable medium. The memory 920 may be volatile memory (such as registers, a cache, a random access memory (RAM)), a non-volatile memory (such as a read-only memory (ROM), an electrically erasable programmable read-only memory (EEPROM), a flash memory), or some combination of them. The storage device 930 may be a removable or non-removable medium, and may include machine readable medium such as flash drives, disks, or any other medium that may be used to store information and/or data (such as training data for training) and may be accessed within the computing device/system 900.

The computing device/system 900 may further include additional removable/non-removable, volatile/nonvolatile storage medium. Although not shown in FIG. 9, a disk driver for reading from or writing to a removable, non-volatile disk (such as a “floppy disk”) and an optical disk driver for reading from or writing to a removable, non-volatile optic disk may be provided. In these cases, each driver may be connected to the bus (not shown) by one or more data medium interfaces. The memory 920 may include a computer program product 925, which has one or more program modules configured to execute various methods or acts of various embodiments of the present disclosure.

The communication unit 940 communicates with a further computing devices through the communication medium. Additionally, the functionality of the components of the computing device/system 900 may be implemented in a single computing cluster or multiple computing machines which may communicate through communication connections. Therefore, the computing device/system 900 may be operated in a networked environment using logical connections with one or more other servers, network personal computers (PCs), or another network node.

The input device 950 may be one or more input devices, such as a mouse, a keyboard, a trackball, etc. The output device 960 may be one or more output devices, such as a display, a speaker, a printer, etc. The computing device/system 900 may also communicate with one or more external devices (not shown) as needed through the communication unit 940, such as storage devices, display devices, etc., to communicate with one or more devices that enable users to interact with the computing device/system 900, or to communicate with any device (such as a network card, a modem, etc.) that enables the computing device/system 900 to communicate with one or more other computing devices. Such communication may be performed via an input/output (I/O) interface (not shown).

According to the exemplary embodiments of the present disclosure, a computer readable storage medium is provided, on which computer executable instructions or computer programs are stored, wherein the computer-executable instructions or computer programs are executed by a processor to implement the methods described above.

According to the example implementations of the present disclosure, a computer program product is also provided, which is tangibly stored on a non-transient computer readable medium and includes computer-executable instructions, which are executed by a processor to implement the methods described above.

Herein, various aspects of the present disclosure are described with reference to flowcharts and/or block diagrams of the methods, apparatuses, devices, and computer program products implemented in accordance with the present disclosure. It should be understood that each block in the flowchart and/or block diagram, and the combination of each block in the flowchart and/or block diagram, may be implemented by computer readable program instructions.

These computer-readable program instructions may be provided to the processing units of general-purpose computers, specialized computers, or other programmable data processing devices to produce a machine that generates an apparatus to implement the functions/actions specified in one or more blocks in the flow chart and/or the block diagram when these instructions are executed through the computer or other programmable data processing apparatuses. These computer-readable program instructions may also be stored in a computer-readable storage medium. These instructions enable a computer, a programmable data processing apparatus and/or other devices to work in a specific way. Therefore, the computer-readable medium containing the instructions includes a product, which includes instructions to implement various aspects of the functions/actions specified in one or more blocks in the flowchart and/or the block diagram.

The computer-readable program instructions may be loaded onto a computer, other programmable data processing apparatus, or other devices, so that a series of operational steps may be executed on a computer, other programmable data processing apparatus, or other devices, to generate a computer-implemented process, such that the instructions which execute on a computer, other programmable data processing apparatuses, or other devices implement the functions/acts specified in one or more blocks in the flowchart and/or the block diagram.

The flowchart and the block diagram in the drawings show the possible architecture, functions and operations of the system, the method and the computer program product implemented in accordance with the present disclosure. In this regard, each block in the flowchart or the block diagram may represent a part of a unit, a program segment or instructions, which contains one or more executable instructions for implementing the specified logic function. In some alternative implementations, the functions labeled in the block may also occur in a different order from those labeled in the drawings. For example, two consecutive blocks may actually be executed in parallel, and sometimes may also be executed in a reverse order, depending on the functionality involved. It should also be noted that each block in the block diagram and/or the flowchart, and combinations of blocks in the block diagram and/or the flowchart, may be implemented by a dedicated hardware-based system that executes the specified functions or acts, or by the combination of dedicated hardware and computer instructions.

Each implementation of the present disclosure has been described above. The above description is an example, not exhaustive, and is not limited to the disclosed implementations. Without departing from the scope and spirit of the described implementations, many modifications and changes are obvious to ordinary skill in the art. The selection of terms used in the present disclosure aims to best explain the principles, practical application or improvement of technology in the market of each implementation, or to enable other ordinary skill in the art to understand the various implementations disclosed herein.

1. A method for evaluating model performance, comprising:
determining, at a client node, a plurality of predicted classification results corresponding to a plurality of data samples by comparing a plurality of predicted scores to a score threshold, the plurality of predicted scores being output by a machine learning model for the plurality of data samples, the plurality of predicted classification results indicating that the plurality of data samples are predicted to belong to a first category or a second category, respectively;
determining values of a plurality of metric parameters associated with a predetermined performance indicator of the machine learning model based on differences between the plurality of predicted classification results and a plurality of ground-truth classification results corresponding to the plurality of data samples;
applying perturbation to the values of the plurality of metric parameters, to obtain perturbed values of the plurality of metric parameters; and
sending the perturbed values of the plurality of metric parameters to a server node.

2. The method of claim 1, further comprising:
receiving the score threshold from the server node.

3. The method of claim 1, wherein determining the values of the plurality of metric parameters comprises determining, based on the differences, at least one of the following:
a first number of first-type data samples among the plurality of data samples, a predicted classification result and a ground-truth classification result corresponding to a first-type data sample both indicating the first category;
a second number of second-type data samples among the plurality of data samples, a predicted classification result and a ground-truth classification result corresponding to a second-type data sample both indicating the second category;
a third number of third-type data samples among the plurality of data samples, a predicted classification result corresponding to a third-type data sample indicating the first category and a ground-truth classification result corresponding to the third-type data sample indicating the second category; or
a fourth number of fourth-type data samples among the plurality of data samples, a predicted classification result corresponding to a fourth-type data sample indicating the second category, and a ground-truth classification result corresponding to the fourth-type data sample indicating the first category.

4. The method of claim 3, wherein applying the perturbation to the values of the plurality of metric parameters comprises:
for at least one of the first, the second, the third, and the fourth numbers, applying perturbation to the at least one number by the following:
determining a sensitivity value related to the perturbation;
determining a random perturbation distribution based on the sensitivity value and a label differential privacy mechanism; and
applying the perturbation to the at least one number based on the random perturbation distribution.

5. The method of claim 1, wherein the predetermined performance indicator at least comprises an area under curve (AUC) of a receiver operating characteristic (ROC) curve.

6. A method for evaluating model performance, comprising:
receiving, at a server node, perturbed values of a plurality of metric parameters from at least one group of client nodes associated with a predetermined performance indicator of a machine learning model, respectively;
for each of the at least one group of client nodes, aggregating the perturbed values of the plurality of metric parameters from the group of client nodes in a metric parameter-wise way, to obtain aggregated values of the plurality of metric parameters respectively corresponding to the at least one group; and
determining a value of the predetermined performance indicator based on at least one score threshold value respectively associated with the at least one group, and the aggregated values of the plurality of metric parameters respectively corresponding to the at least one group.

7. The method of claim 6, further comprising:
sending the at least one score threshold to client nodes in the respective associated group.

8. The method of claim 6-er 7, wherein for a given client node, the perturbed values of the plurality of metric parameters comprise at least one of the following:
a first perturbed number of first-type data samples among a plurality of data samples at the given client node, a first-type data sample being labeled as a first category and predicted as the first category;
a second perturbed number of second-type data samples among the plurality of data samples, a second-type data sample being labeled as a second category and predicted as the second category;
a third perturbed number of third-type data samples among the plurality of data samples, a third-type data sample being labeled as the second category but predicted as the first category; and
a fourth perturbed number of fourth-type data samples among the plurality of data samples, a fourth-type data sample being labeled as the first category but predicted as the second category; and
wherein the predicting is based on a comparison between a predicted score output by the machine learning model and a score threshold associated with a group where the given client node is located.

9. The method of claim 8, wherein the at least one group comprises a plurality of groups and the at least one score threshold comprises a plurality of score thresholds, and wherein determining the value of the predetermined performance indicator comprises:
determining a receiver operating characteristic (ROC) curve of the machine learning model based on the plurality of score thresholds and the aggregated values of the plurality of metric parameters; and
determining an area under curve (AUC) of the ROC.

10. The method of claim 6, wherein client nodes in one of the at least one group are different from client nodes of another group of the at least one group.

11-18. (canceled)

19. An electronic device, comprising:
at least one processing unit; and
at least one memory coupled to the at least one processing unit and storing instructions for execution by the at least one processing unit that, when executed by the at least one processing unit, cause the device to perform acts comprising:
determining, at a client node, a plurality of predicted classification results corresponding to a plurality of data samples by comparing a plurality of predicted scores to a score threshold, the plurality of predicted scores being output by a machine learning model for the plurality of data samples, the plurality of predicted classification results indicating that the plurality of data samples are predicted to belong to a first category or a second category, respectively;
determining values of a plurality of metric parameters associated with a predetermined performance indicator of the machine learning model based on differences between the plurality of predicted classification results and a plurality of ground-truth classification results corresponding to the plurality of data samples;
applying perturbation to the values of the plurality of metric parameters, to obtain perturbed values of the plurality of metric parameters; and
sending the perturbed values of the plurality of metric parameters to a server node.

20. A non-transitory computer readable storage medium having a computer program stored thereon which, when executed by a processor, implements acts comprising:
determining, at a client node, a plurality of predicted classification results corresponding to a plurality of data samples by comparing a plurality of predicted scores to a score threshold, the plurality of predicted scores being output by a machine learning model for the plurality of data samples, the plurality of predicted classification results indicating that the plurality of data samples are predicted to belong to a first category or a second category, respectively;
determining values of a plurality of metric parameters associated with a predetermined performance indicator of the machine learning model based on differences between the plurality of predicted classification results and a plurality of ground-truth classification results corresponding to the plurality of data samples;
applying perturbation to the values of the plurality of metric parameters, to obtain perturbed values of the plurality of metric parameters; and
sending the perturbed values of the plurality of metric parameters to a server node.

21. The electronic device of claim 19, wherein the acts further comprises:
receiving the score threshold from the server node.

22. The electronic device of claim 19, wherein determining the values of the plurality of metric parameters comprises determining, based on the differences, at least one of the following:
a first number of first-type data samples among the plurality of data samples, a predicted classification result and a ground-truth classification result corresponding to a first-type data sample both indicating the first category;
a second number of second-type data samples among the plurality of data samples, a predicted classification result and a ground-truth classification result corresponding to a second-type data sample both indicating the second category;
a third number of third-type data samples among the plurality of data samples, a predicted classification result corresponding to a third-type data sample indicating the first category and a ground-truth classification result corresponding to the third-type data sample indicating the second category; or
a fourth number of fourth-type data samples among the plurality of data samples, a predicted classification result corresponding to a fourth-type data sample indicating the second category, and a ground-truth classification result corresponding to the fourth-type data sample indicating the first category.

23. The electronic device of claim 22, wherein applying the perturbation to the values of the plurality of metric parameters comprises:
for at least one of the first, the second, the third, and the fourth numbers, applying perturbation to the at least one number by the following:
determining a sensitivity value related to the perturbation;
determining a random perturbation distribution based on the sensitivity value and a label differential privacy mechanism; and
applying the perturbation to the at least one number based on the random perturbation distribution.

24. The electronic device of claim 19, wherein the predetermined performance indicator at least comprises an area under curve (AUC) of a receiver operating characteristic (ROC) curve.

25. The non-transitory computer readable storage medium of claim 20, wherein the acts further comprises:
receiving the score threshold from the server node.

26. The non-transitory computer readable storage medium of claim 20, wherein determining the values of the plurality of metric parameters comprises determining, based on the differences, at least one of the following:
a first number of first-type data samples among the plurality of data samples, a predicted classification result and a ground-truth classification result corresponding to a first-type data sample both indicating the first category;
a second number of second-type data samples among the plurality of data samples, a predicted classification result and a ground-truth classification result corresponding to a second-type data sample both indicating the second category;
a third number of third-type data samples among the plurality of data samples, a predicted classification result corresponding to a third-type data sample indicating the first category and a ground-truth classification result corresponding to the third-type data sample indicating the second category; or
a fourth number of fourth-type data samples among the plurality of data samples, a predicted classification result corresponding to a fourth-type data sample indicating the second category, and a ground-truth classification result corresponding to the fourth-type data sample indicating the first category.

27. The non-transitory computer readable storage medium of claim 26, wherein applying the perturbation to the values of the plurality of metric parameters comprises:
for at least one of the first, the second, the third, and the fourth numbers, applying perturbation to the at least one number by the following:
determining a sensitivity value related to the perturbation;
determining a random perturbation distribution based on the sensitivity value and a label differential privacy mechanism; and
applying the perturbation to the at least one number based on the random perturbation distribution.

28. The non-transitory computer readable storage medium of claim 18, wherein the predetermined performance indicator at least comprises an area under curve (AUC) of a receiver operating characteristic (ROC) curve.
